(19) United States
(12) Patent Application Publication
(10) Pub. No.: US 2025/0028599 A1
(43) Pub. Date: Jan. 23, 2025

(54) MULTIPLE ERROR RESILIENCY PUT OPERATION WITH EARLY CONFIRMATION

(71) Applicant: SCALITY, S.A., Paris (FR)

(72) Inventors: Benoit ARTUSO, Hadol (FR); Stéphane CANCE, Montreuil (FR); Giorgio REGNI, Albany, CA (US); Lam Pham SY, Issy-les-Moulineaux (FR)

(21) Appl. No.: 18/223,438

(22) Filed: Jul. 18, 2023

(51) Int. Cl. G06F 11/10; G06F 11/07

(52) U.S. Cl. CPC G06F 11/1076; G06F 11/0772; G06F 11/0793

(57) ABSTRACT

A method is described. The method includes receiving a PUT operation request from a user to store a data item. The method also includes sending S PUT commands to S working storage devices to respectively store S replicas or extents for the data item. The method also includes confirming to the user that the data item was stored after receiving X acknowledgments from the S working devices where X<S. The method also includes, in response to a crash, reading non volatile records for the S working devices that record successful stores performed by the S working devices having corresponding acknowledgements that were not responded to. The method also includes recognizing from the non volatile records that less than S of the S replicas or extents were successfully stored into the S working devices. The method includes causing those of the S replicas or extents that were not successfully stored to be stored to complete the PUT operation.

### BACKGROUND

With the emergence of “big data” computing, more and more applications are seeking faster access to mass storage, while, at the same time, preserving data integrity.

### BRIEF DESCRIPTION OF THE FIGURES

FIG. 1 depicts replication protection;

FIG. 2 depicts erasure encoding protection;

FIGS. 3a and 3b depict a PUT operation and a PUT operation with repair, respectively;

FIGS. 4a and 4b pertain to an improved PUT operation with repair;

FIG. 5 depicts a computing system.

### DETAILED DESCRIPTION

Mass storage systems are measured, in part, by their reliability. Here, there is some probability that the underlying physical storage devices (e.g., hard disk drives (HDDs), solid state drives (SSDs) that are actually storing customer/user information will fail. As such, mass storage systems are often designed with certain features that prevent loss of data even if there is a failure of the physical device(s) that store the data.

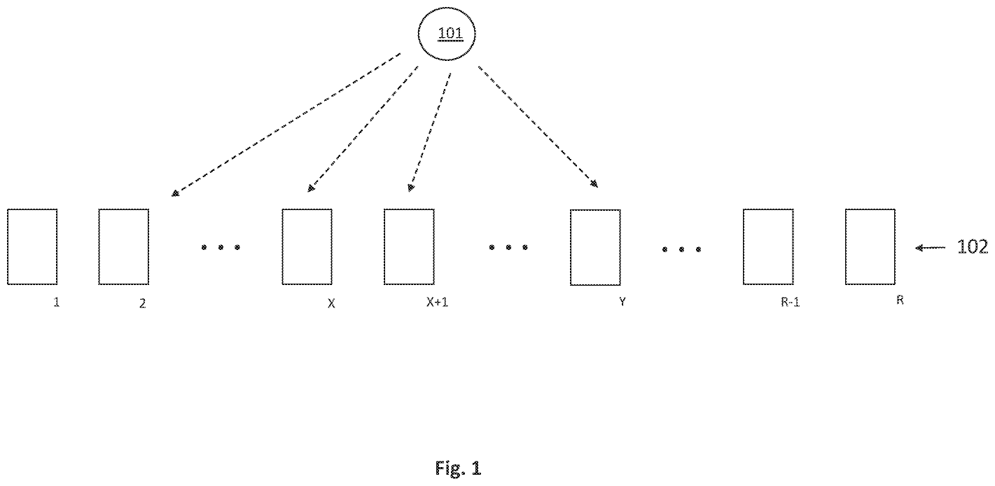

FIG. 1 depicts a first reliability technique, referred to as replication. In the case of replication, for instance in the case where an object 101 is being stored into a mass storage system containing R multiple storage devices 102, the object is replicated some number of times and each different instance of the object is stored in one or more different physical storage device(s). As such, if one of the devices fails, there are still additional copies of the object in the storage system. In the basic example of FIG. 1, the object being stored 101 is replicated four times and stored in storage devices 2, X, X+1 and Y.

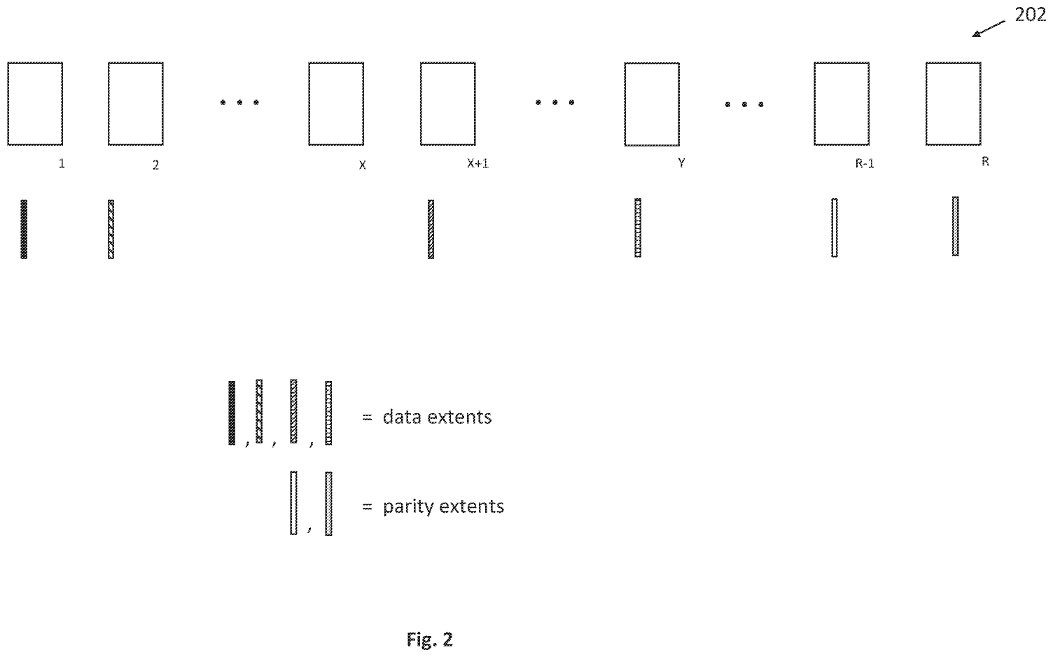

Another technique is erasure coding. In the case of erasure coding, referring to FIG. 2, user/customer data is protected with parity information. Here, one or more objects that are to be stored into the storage system are broken down into k separate units of data, referred to as data extents, and the k different data extents are stored on different physical storage devices. The data content of the k data extents are also processed by a mathematical algorithm which generates n parity extents. The n parity extents are then stored in additional different physical storage devices such that each of the k+n extents are stored in a different physical storage device. That is, k+n different storage devices are used to store the k data extents and the n parity extents.

If up to n of any of the k+n storage devices fail, the original k data extents can be recovered by processing the remaining extents with a corresponding mathematical algorithm. FIG. 2 depicts a basic example in which there are four data extents (k=4) and two parity extents (n=2) which form a (4,2) extent group (the two parity extents have been calculated from the four data extents). As observed in FIG. 2, the four data extents are stored in physical storage devices 1, 2, X-1 and Y whereas the two parity extents have been stored in physical storage devices R-1 and R.

Here, if up to two of any of the six physical storage devices (1, 2, X-1, Y, R-1 and R) suffer a failure, the content of the k data extents can be completely recovered by processing the remaining four or five extents (regardless of their data or parity status) with a corresponding mathematical algorithm.

Traditionally, one or the other of replication and erasure coding has been used to protect a particular data item (e.g. object) that is stored in a storage system. Moreover, the total number of replications in the case of replications, or, the k+n total number of extents in an erasure encoded extent group have traditionally been set equal to some number S of working physical storage devices (“working devices”) in a storage system. That is, in the case of replication, S replications of a data object are created and stored in S working devices, or, in the case of erasure encoding, k+n=S total extents are created and separately stored in S working devices.

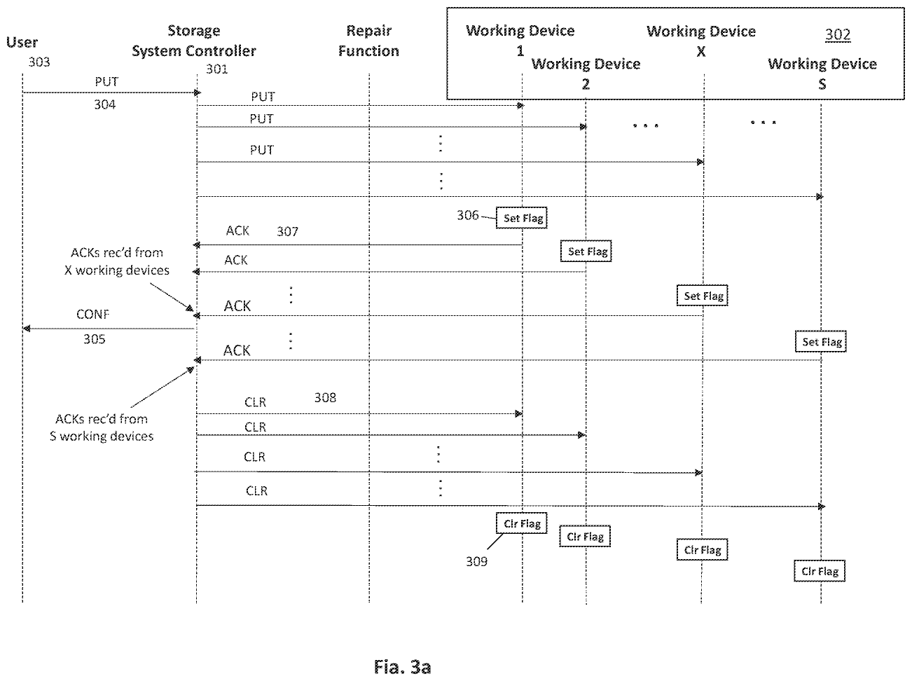

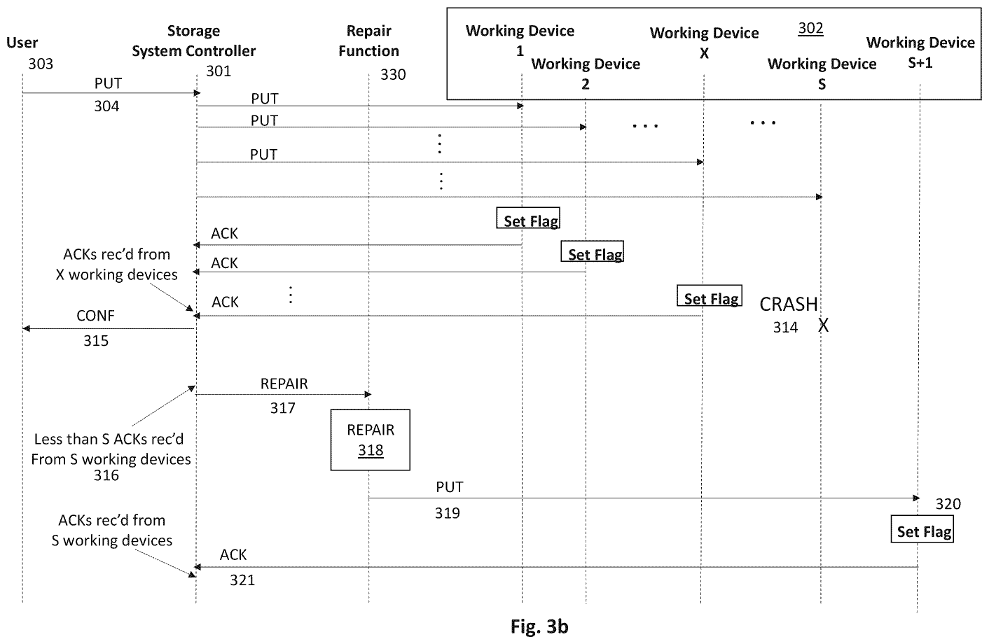

FIG. 3a depicts the operation of a storage system having a controller 301 and at least S working devices 302. The controller receives PUT commands from one or more users 303 and stores the items (e.g., objects, files, blocks) associated with the PUT commands into S of the working devices 302 according to a replication and/or erasure coding scheme.

In order to improve the performance of the storage system from the perspective of the users 303, the controller 301 will send a confirmation message 305 to a user that a PUT operation 304 was successful before all of the replication or extents are successfully stored in all S devices. For example, when a working device successfully writes a replica/extent for a particular PUT operation 304, the working device sets an internal flag 306 and sends an acknowledgement message 307 back to the controller 301 (the message can include, e.g., an identity of the PUT operation (e.g., a PUT operation ID, an address that the PUT operation writes to, etc.)).

The controller 301 will send a confirmation message 305 to the user 303 that originally submitted the PUT operation 304 after X replications or extents are successfully stored where X<S (in the case of erasure coding, n≤X, so that the item stored by the PUT operation 304 can be later recovered according to the erasure coding recovery process). That is, the controller 301 will send a confirmation message 305 to the user 303 after X acknowledgements are received from X of the S working devices 302 that were targeted to store the PUT operation's replicas/extents.

After the controller 301 has received S acknowledgments from the S working devices that were targeted to store one of the PUT operation's replicas/extents, the controller 301 sends a clear message 308 to each of the S working devices. In response, each of the S working devices clears 309 its respective flag for the PUT operation 304, at which point, the PUT operation is deemed completely committed within the system.

It is possible that, after a confirmation message 305 has been sent by the controller 301 to a user 303 for a particular PUT operation, less than all S devices are ultimately written to successfully for the PUT operation.

For example, referring to FIG. 3b, working device S crashes 314 which prevents one of the replicas or extents for a PUT operation 304 from being written. In this case, upon realizing that less than S of the PUT operation's working devices were successfully written to 316 (e.g., after a time period has elapsed since receipt of the initial PUT operation 304), the controller 301 sends a REPAIR message 317 to a repair function 330. The REPAIR message 317, e.g., identifies the PUT operation 304 and those of the S devices that were successfully written to (those of the S devices from which the controller 301 received an acknowledgment).

The repair function 330, in response, performs a repair process 318 that includes: 1) reading one or more of the successfully stored replicas/extents from their respective working devices (not shown in FIG. 3b); and, 2) determining the information that needs to be stored in one or more other working devices in order to fully complete the PUT operation 304.

In the particular example of FIG. 3b, S−1 working devices were successfully written to initially. As such, the repair function 330 writes 319 the appropriate missing replica or extent into one other working device (working device S+1 as observed in FIG. 3b). By contrast, if S−2 working devices were successfully written to initially, the repair function would write the two missing replicas or extents into two other working devices (e.g., working devices S+1 and S+2 (not shown)).

In the case of a replication scheme, the repair process 318 reads one replica from any of the working devices that were successfully written to initially and rewrite the replica into as many other working devices as are needed to ensure S working devices contain a replica.

In the case of erasure coding, the repair process 318 will read k or more extents that were successfully written initially, process the extents to determine the original data item that the PUT operation intended to store, recalculate the k+n set of extents for the item, determine which extent(s) were not successfully stored initially (by comparing the recalculated set of extents against the retrieved extents) and then store the missing extent(s) into respective other working device(s) to complete the storage of S extents for the item.

In the particular example of FIG. 3b, as mentioned above, S−1 replicas/extents were written to successfully. As such, the repair function 330 only writes 319 one extent into working device S+1 to complete the PUT function 304 (S replicas/extents are stored in S working devices). Working device S+1 sets a flag 320 as part of its successfully store of the replica/extent and sends an acknowledgment 321 to the controller 301. After receipt of the acknowledgement 321, the controller 301 recognizes that it has received S acknowledgements for the PUT operation. As such, as per operations 308 and 309 of FIG. 3a, the controller sends respective clear messages to the S working devices and the S working devices clear their respective flags in response (not shown in FIG. 3b).

Unfortunately, the controller 301 can crash after the controller 301 has confirmed 305 a PUT operation to a user 303 but before the controller receives S acknowledgements from S working devices for the PUT operation. In this case, it is not clear which of the PUT operation's S devices where successfully written to and which ones were not. In extreme cases, the crash can be severe enough that the existence of the PUT operation is lost even though some replicas/extents were successfully written before the crash.

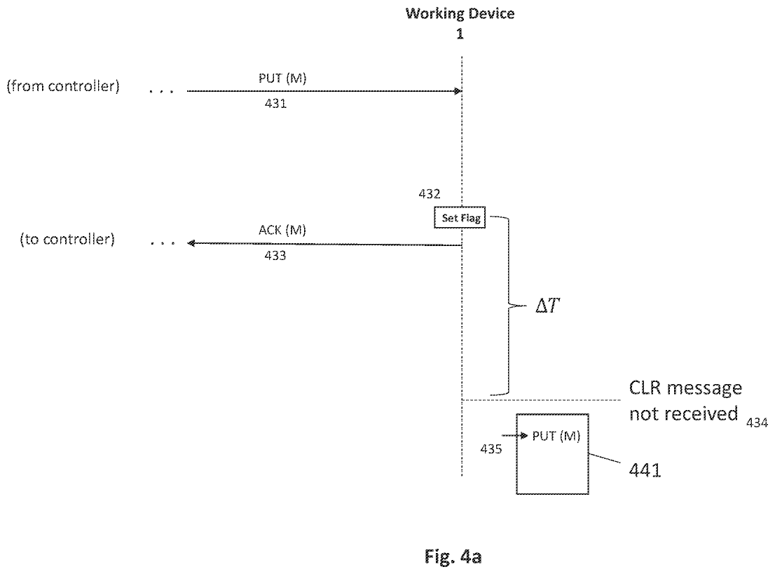

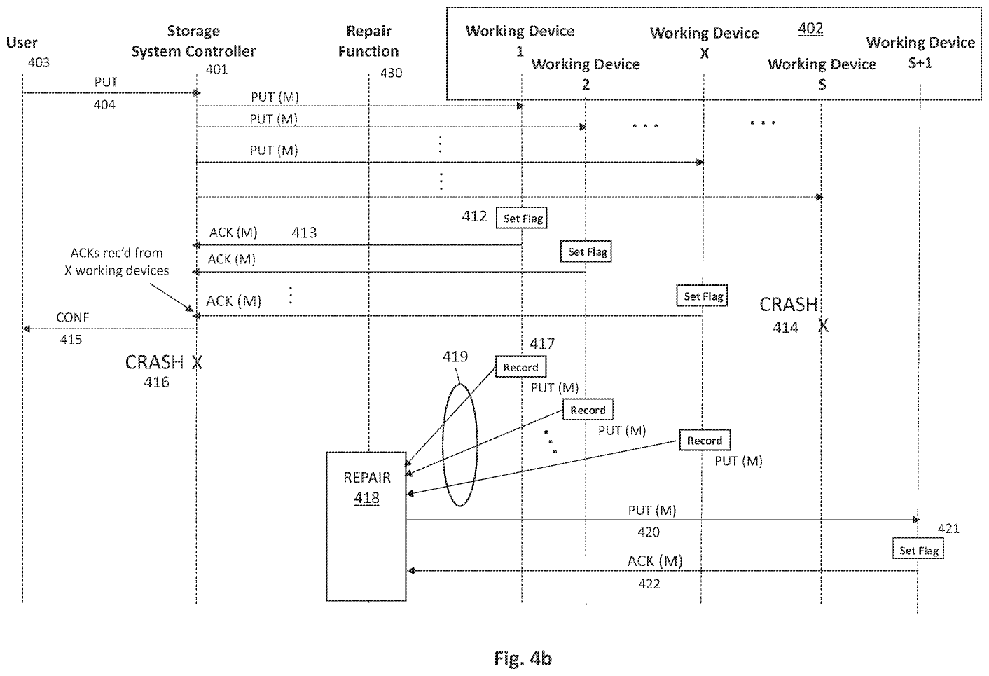

FIGS. 4a-4XXX pertain to an improved approach that commits into the working devices information that the repair system 330 can use to restore and complete a PUT operation after a controller crash as described above.

FIG. 4a depicts the improved approach from the perspective of a working device. As observed in FIG. 4a, a working device is configured to store 435 a non volatile record 441 of a successfully written replica/extent for a particular PUT operation if a period of time ΔT expires after the replica/write 432 has been successfully written 432 but the message to clear the write's flag has not been received from the controller 434.

As observed in FIG. 4a, a working device receives a command 431 to store a replica/extent for a particular PUT operation. The working device successfully stores the extent, sets its flag 432 and sends an acknowledgement to the controller 433. A period of time ΔT then expires after which no clear message is received from the controller. As such, the working device stores 435 a record of the PUT operation in a non volatile record 441. Note that if a particular working device is busy storing many replicas/extents for many different PUT operations when the controller crashes, a larger number of different PUT operations can be identified in the non volatile record 441.

The non volatile record 441 includes some identifier of the PUT operation ((e.g., a PUT operation ID, an address that the PUT operation wrote to (represented in FIG. 4a as “M”), etc.) and whether the item that was saved for the PUT operation was a replica or an extent. If a clear message is ultimately received from the controller for a particular PUT operation after a non-volatile record of the PUT operation is created 435, the flag is cleared and the identity of the PUT operation is deleted from the non-volatile record.

FIG. 4b shows how the non volatile records of multiple working devices are used in the event the controller crashes leaving a PUT operation in limbo. FIG. 4b depicts the scenario of FIG. 3b but where the controller crashes 416 just after the confirmation message is sent 415 to the user 401. Additionally, as observed in FIG. 4b, working devices 1 through S−1 successfully write their respective replica/extent for the PUT operation 404, set their respective flags 412, and send 413 an acknowledgement 413 to the controller. Working device S, however, crashes 414 resulting in the Sth replica/extent not being written.

Because of the controller crash 416, working devices 1 through S−1 never receive a clear message. As such, after the respective timeout 434, each of working devices 1 through S−1 records its successful write for the PUT operation 404 in its respective non volatile record 417.

The repair function 430 begins the controller crash recovery process 418 and reads 419 the non-volatile records of the storage system's working devices. Notably, because the controller 401 does not send a confirmation 415 to a user 403 for a PUT operation 404 until the controller 401 receives enough (X) acknowledgements to completely commit the PUT operation, the in-limbo PUT operation 404 can be transitioned to a fully committed PUT operation by the repair process 418.

The repair process 418 then analyzes the non volatile records from the working devices. As mentioned above, there can be many PUT operations that are in-limbo and recorded on the working devices' respective non volatile record. FIG. 4b depicts a particular scenario in which one of the working devices (working device S) crashed 414 during execution of a PUT operation 404. However, other scenarios can exist for other in-limbo PUT operations. Examples include, to name a few, all working devices were successfully written to during execution of a PUT operation, more than one working device crashed during execution of a PUT operation, etc.

The following discussion addresses the set of possible scenarios for any in-limbo PUT operation.

For any in-limbo PUT operation that was protected by a replication scheme, the repair process: 1) determines which of the working devices that were targeted by the PUT operation successfully stored its replica; and, 2) writes any missing replicas into a respective working device.

In the case of 1) above, the non volatile records from the working devices will reveal any PUT operation for which at least one replica was successfully written but for which no clear message was received. If any PUT operation did not successfully write at least one replica the controller 403 would not have sent a confirmation to the PUT operation's user and the user will ultimately try to resend the PUT operation.

For those of the PUT operations for which at least one PUT operation was successfully written, if after analyzing the non volatile record data the repair function recognizes there are S different records from S different working devices, the PUT operation was fully committed in the system at the moment of the crash and the repair function 430 merely needs to send a clear message to the S working devices and command the S working devices to delete their non-volatile record of PUT operation.

For those of the PUT operations for which at least one PUT operation was successfully written, if after analyzing the non-volatile record data the repair function recognizes there are less than S different records from less than S different working devices, the repair function reads the stored item from one of the working devices that successfully stored the item and writes the item into as many other working devices are needed to result in S copies of the item in S different working devices. Thus, if there are S−1 non volatile records of a successful write from S−1 working devices (the situation of FIG. 4b) the repair function will write 420 the item in one other working device. By contrast, if there are S−2 non volatile records of a successful write from S−2 working devices the repair function will write two replicas of the item in two other working devices, etc.

Likewise, for any in-limbo PUT operation that was protected by an erasure encoding scheme, the repair function can: 1) determine which of the working devices that were targeted by the PUT operation successfully stored its extent; and, 2) write any missing extents into one or more respective working devices.

In the case of 1) above, the non-volatile records from the working devices will reveal any PUT operation for which at least one extent was successfully written but for which no clear message was received. If any PUT operation did not successfully write at least X extents the controller would not have sent a confirmation to the PUT operation's user and the user will ultimately try to resend the PUT operation. In this case, the repair function 430 can command the less than X working devices that successfully stored an extent to delete their extent, flag and non-volatile record of the PUT operation.

For those of the PUT operations for which at least X working devices successfully wrote an extent, if after analyzing the non volatile record data the repair function 430 recognizes there are S different records from S different working devices, the PUT operation was fully committed in the system at the moment of the controller crash and the repair function 430 merely needs to inform the S working devices to delete their non-volatile record of the PUT operation.

For those of the PUT operations for which at least X working devices successfully wrote an extent, if after analyzing the non volatile record data the repair function 430 recognizes there are less than S different records from less than S different working devices, the repair function 430 reads the set of X or more extents from the X or more working devices that successfully stored their respective extent (depicted in FIG. 4b).

The repair function 430 then processes the X or more extents to fully recover the item from the user that the PUT operation stored. The repair function 430 then performs the erasure encoding process on the item to generate a set of S extents for the item. The repair function 430 then compares the set of newly generated S extents to the set of less than S extents that were just read from the working devices to identify which of the S extents were not successfully written.

The repair function then writes those of the S extents that were not successfully written into respective, different working devices (in FIG. 4b, only one extent is missing and therefore only extent is written 420). At this point, the PUT operation is completely committed in the system. The repair function 430 sends a message to each of the working devices that initially wrote one of the PUT operation's extents successfully to clear its respective non-volatile record of the PUT operation.

In the example of FIG. 4b, the repair function 430 would send a message to working devices 1 through S−1 to clear their respective non-volatile record of the PUT operation. After working device S+1 successfully writes the extent, sets its flag 421 and sends an acknowledgment 422 to the repair function 430, the repair function 430 sends a clear message to working devices 1 through S−1 and S+1 to clear their respective flags which fully completes the PUT operation 404. The repair function 430 also commands working devices 1 through S−1 to delete their non-volatile record of the PUT operation.

Note that in scenarios (whether replica protected or erasure encoding protected) where X or more working devices were successfully written to but the controller 401 crashes before a confirmation 415 is sent to the user 403, the repair function 430 can recognize the existence of the X or more successful writes from its analysis of the working devices' non-volatile records and send the confirmation message to the user on behalf of the controller. The repair function 430 can then proceed to write missing replicas/extents, if any, to commit S replicas/extents for the PUT function as described at length above.

According to various embodiments, a replica/extent is stored within its respective working device at an address that can be referred to as a “key”. Here, the non-volatile record 411 within each working device can list the keys of the successfully stored data items for which no clear message was received after the timeout.

With respect to keeping track of successful writes for a particular PUT operation at the controller 401 and/or repair function 430, according to one approach, each write operation into each working device is treated as a separate transaction that is uniquely tracked. For example, for each in-process PUT operation there are S unique records (one for each replica/extent) created in memory of the controller 401 or the repair function 430.

Each record can identify the PUT operation, the working device that stores the replica/extent to which the record pertains, and the key/address in the working device where the replica/extent is stored. The PUT operation that is sent by the controller 401 or repair function 430 to the working device to store the particular replica/extent can include this same information. After a successful write, the working device can append any/all of this information to the acknowledgement that is sent to the controller/repair function. Likewise, any/all of this information can be included in the non volatile record that is kept in the working device if the working device does not receive a clear message from the controller/repair function after the acknowledgement is sent.

For high performance storage systems, however, the users can send large numbers of PUT operations to the system in short periods of time. With large numbers of outstanding PUT operations and S memory records per PUT operation, the amount of memory consumed keeping track of the write activity into the various working devices can become unreasonably large.

As such, according to one approach, the controller/repair function creates only one record in memory per PUT operation and a counter is maintained within the record to count how many successful acknowledgements have been received for the PUT operation. For example, the identifier of the PUT operation can be viewed as a “batch ID” for the set of S write operations that are performed by the S different working devices for the PUT operation.

When a new PUT operation is received by the system, the controller creates a new record in memory based on the batch ID. The record's count value then increments each time the controller/repair function receives an acknowledgment from one of the PUT operation's working devices. A confirmation for the PUT operation can be sent to the user once the counter reaches a value of X. Likewise, a clear message can be sent to the PUT operation's working devices once the count value reaches a value of S. If the count value settles in a range that is greater than or equal to X but less than S, the controller can ask the repair function to repair the PUT operation as described above and/or the repair function can initiate/continue a repair process.

One issue concerns the key value for the S different replicas/extents of a PUT operation. If the key values are random or quasi-random, the controller and/or repair function ideally has the individual addresses stored in memory which can also expand memory consumption.

Alternatively, the addresses can be generated according to some mathematical function. For example, the addresses are generated by a hash function performed on a seed value (the seed value can be, e.g., some portion of the content of the data item provided by the user that is to be written by the PUT operation).

In this case, for address generation purposes, only the seed value is stored in memory, e.g., along with the counter value in the memory entry that is created for the PUT operation. The PUT operation's S different addresses can then be calculated from the common seed value. The seed value can be sent by the controller to the S working devices during the execution of the PUT operation. The S working devices can include the seed value in the non volatile record for those successful writes for which a clear message was not sent so that the repair function can determine the addresses from the seed value. Moreover, the repair function can use the seed value to recognize entries in the respective non volatile records of different working devices as belonging to a same PUT operation (entries from different records having a same seed value belong to a same PUT operation).

In yet another approach that is suggested by FIGS. 4a and 4b, the S different replicas/extents for a same PUT operation have a same key value (“M”). That is, the different replicas/extents of a same PUT operation are stored at the same address across the S working devices. In this case, the key value can also act as an identifier of the PUT operation. Thus, the memory entry that is created for the PUT operation and includes the counter value can be referred to by the PUT operation's key value and/or include the PUT operation's key value.

When a working device sends an acknowledgement to the controller or repair function, the acknowledgement includes the key value M. The key value M is then used by the controller or repair function to find the PUT operation's entry in memory and its counter value. The working devices store the key value for a particular successful write in their respective non-volatile records if no clear message is received. The key value is sufficient for the repair function to identify entries in the different non volatile records across different working devices that belong to a same PUT operation (entries having a same key belong to a same PUT operation).

The storage system described above can be implemented at various capacity scales including a cloud service or large scale (e.g., large corporation's) proprietary storage system, a storage area network (e.g., composed of a plurality of storage servers interconnected by a network), the storage system of a computer, etc. Here, the controller 401 can be implemented in software that is, e.g., centralized on a single computer system or is distributed across multiple computer systems. A network, such as the Internet, can be located between the controller 401 and the users. Likewise, the repair function 430 can be implemented in software that is, e.g., centralized on a single computer system or is distributed across multiple computer systems. The repair function 430 can be located on the same computer system(s) as the controller 401 and/or different computer system(s). In the case of the later, one or more networks can be located between the controller 401 and the repair function 430. The working devices can also be located on the same computer system(s) as the controller 401 and/or repair functions, and/or, be integrated in different computer system(s) than the controller 401 and/or repair function 430. In the case of the later, one or more networks can be located between the controller 401 and/or repair function 430 and the working devices.

In various embodiments, the storage system is an object storage system. As is known in the art, in the case of object storage systems, units of stored information (“objects”), such as the item provided to the system by a user for storage by way of a PUT operation as described above, and/or the replicas/extents that are stored in the working devices, are identified with unique identifiers (“object IDs”) which can also be (or be correlated to) the replicas'/extents' corresponding key values/addresses. Thus, whereas a traditional file system identifies a targeted stored item with a path that flows through a directory hierarchy (“filepath”) to the item, by contrast, in the case of object storage systems, targeted stored items are identified with a unique ID for the object.

In various other embodiments the storage system that implements the teachings above is a file storage system and the above described keys or addresses correspond to a filepath. Here, for ease of interpretation the term “object” is meant to embrace an object in an object storage system as well as a file in a file storage system.

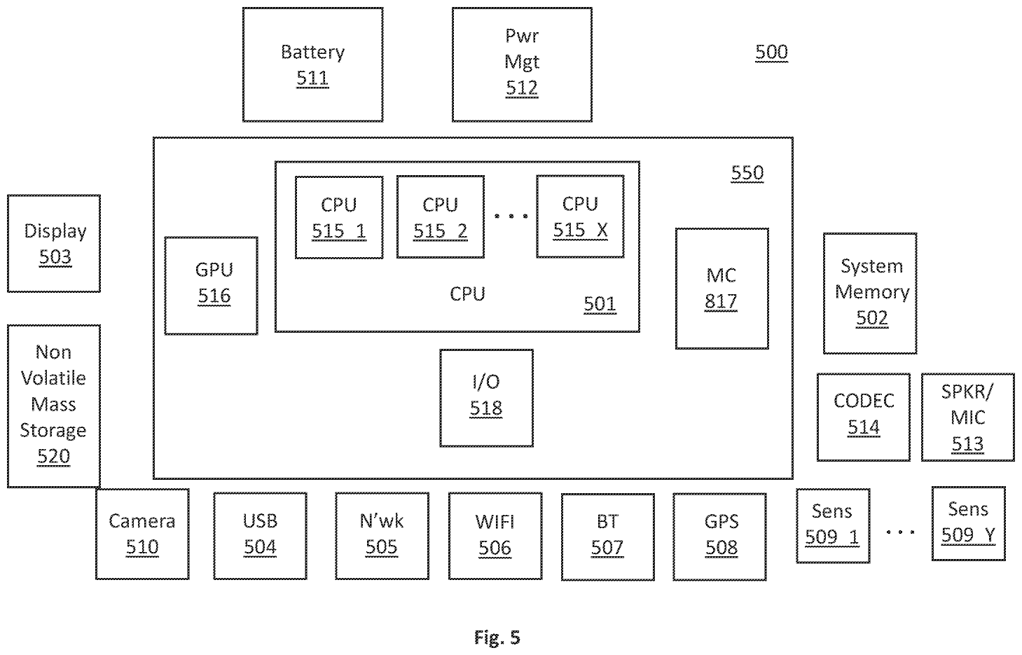

FIG. 5 provides an exemplary depiction of a computing system 500. Any of the aforementioned storage systems can be constructed, e.g., from one or more computers having components of the computing system 500 of FIG. 5 including one or more non volatile mass storage devices 520 that correspond to the physical storage devices described above.

As observed in FIG. 5, the basic computing system 500 may include a central processing unit (CPU) 501 (which may include, e.g., a plurality of general purpose processing cores 515_1 through 515_X) and a main memory controller 517 disposed on a multi-core processor or applications processor, main memory 502 (also referred to as “system memory”), a display 503 (e.g., touchscreen, flat-panel), a local wired point-to-point link (e.g., universal serial bus (USB)) interface 504, a peripheral control hub (PCH) 518; various network I/O functions 505 (such as an Ethernet interface and/or cellular modem subsystem), a wireless local area network (e.g., WiFi) interface 506, a wireless point-to-point link (e.g., Bluetooth) interface 507 and a Global Positioning System interface 508, various sensors 509_1 through 509_Y, one or more cameras 510, a battery 511, a power management control unit 512, a speaker and microphone 513 and an audio coder/decoder 514.

An applications processor or multi-core processor 550 may include one or more general purpose processing cores 515 within its CPU 501, one or more graphical processing units 516, a main memory controller 517 and a peripheral control hub (PCH) 518 (also referred to as I/O controller and the like). The general purpose processing cores 515 typically execute the operating system and application software of the computing system. The graphics processing unit 516 typically executes graphics intensive functions to, e.g., generate graphics information that is presented on the display 503. The main memory controller 517 interfaces with the main memory 502 to write/read data to/from main memory 502. The power management control unit 512 generally controls the power consumption of the system 500. The peripheral control hub 518 manages communications between the computer's processors and memory and the I/O (peripheral) devices.

Each of the touchscreen display 503, the communication interfaces 504-507, the GPS interface 508, the sensors 509, the camera(s) 510, and the speaker/microphone codec 513, 514 all can be viewed as various forms of I/O (input and/or output) relative to the overall computing system including, where appropriate, an integrated peripheral device as well (e.g., the one or more cameras 510). Depending on implementation, various ones of these I/O components may be integrated on the applications processor/multi-core processor 550 or may be located off the die or outside the package of the applications processor/multi-core processor 550. The computing system also includes non-volatile mass storage 520 which may be the mass storage component of the system which may be composed of one or more non-volatile mass storage devices (e.g., hard disk drive, solid state drive, etc.). The non-volatile mass storage 520 may be implemented with any of solid state drives (SSDs), hard disk drive (HDDs), etc.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable storage medium for storing the program code. The machine-readable medium can include, but is not limited to, floppy diskettes, optical disks, CD-ROMs, and magneto-optical disks, FLASH memory, ROMs, RAMS, EPROMs, EEPROMs, magnetic or optical cards or other type of media/machine-readable medium suitable for storing electronic instructions. The program code is to be executed by one or more computers.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
receiving a PUT operation request from a user to store a data item;
sending S PUT commands to S working storage devices to respectively store S replicas or extents for the data item;
confirming to the user that the data item was stored after receiving X acknowledgments from the S working devices where X<S;
in response to a crash, reading non volatile records for the S working devices that record successful stores performed by the S working devices having corresponding acknowledgements that were not responded to;
recognizing from the non volatile records that less than S of the S replicas or extents were successfully stored into the S working devices; and,
causing those of the S replicas or extents that were not successfully stored to be stored to complete the PUT operation.

2. The method of claim 1 wherein the crash is a crash of a controller that receives the PUT operation.

3. The method of claim 2 where at least one of the S replicas or extents were not successfully stored because a corresponding one of the S working devices also crashed.

4. The method of claim 2 wherein the recognizing and causing is performed by a repair function that responds to the crash of the controller.

5. The method of claim 1 wherein the non volatile records include respective key values for the successful stores.

6. The method of claim 1 wherein the non volatile records identify the PUT operation for the successful stores.

7. The method of claim 1 further comprising:
receiving respective acknowledgements for the successful storage those of the S replicas or extents; and,
responding to the acknowledgements and the respective acknowledgements.

8. The method of claim 1 further comprising:
receiving a second PUT operation request from a user to store a second data item;
sending S second PUT commands to S second working storage devices to respectively store S second replicas or extents for the second data item;
confirming to the user that the second data item was stored after receiving X acknowledgments from the S second working devices where X<S;
in response to a second crash, reading second non volatile records for the S second working devices that record successful stores performed by the S second working devices having corresponding acknowledgements that were not responded to;
recognizing from the non volatile records that the S second replicas or extents were successfully stored into the S second working devices; and,
responding to the acknowledgements that were not responded to complete the PUT operation.

9. At least one machine readable storage medium containing program code that when processed by at least one processor causes a method to be performed, the method comprising:
receiving a PUT operation request from a user to store a data item;
sending S PUT commands to S storage devices to respectively store S replicas or extents for the data item;
confirming to the user that the data item was stored after receiving X acknowledgments from the S storage devices where X<S;
in response to a crash, reading non volatile records for the S storage devices that record successful stores performed by the S storage devices having corresponding acknowledgements that were not responded to;
recognizing from the non volatile records that less than S of the S replicas or extents were successfully stored into the S storage devices; and,
causing those of the S replicas or extents that were not successfully stored to be stored to complete the PUT operation.

10. The at least one machine readable storage medium of claim 9 wherein the crash is a crash of a controller that receives the PUT operation.

11. The at least one machine readable storage medium of claim 10 where at least one of the S replicas or extents were not successfully stored because a corresponding one of the S storage devices also crashed.

12. The at least one machine readable storage medium of claim 10 wherein the recognizing and causing is performed by a repair function that responds to the crash of the controller.

13. The at least one machine readable storage medium of claim 9 wherein the non volatile records include respective key values for the successful stores.

14. The at least one machine readable storage medium of claim 9 wherein the non volatile records identify the PUT operation for the successful stores.

15. The at least one machine readable storage medium of claim 9 wherein the method further comprises:
receiving respective acknowledgements for the successful storage those of the S replicas or extents; and,
responding to the acknowledgements and the respective acknowledgements.

16. The at least one machine readable storage medium of claim 9 wherein the method further comprises:
receiving a second PUT operation request from a user to store a second data item;
sending S second PUT commands to S second storage devices to respectively store S second replicas or extents for the second data item;
confirming to the user that the second data item was stored after receiving X acknowledgments from the S second storage devices where X<S;
in response to a second crash, reading second non volatile records for the S second storage devices that record successful stores performed by the S second storage devices having corresponding acknowledgements that were not responded to;
recognizing from the non volatile records that the S second replicas or extents were successfully stored into the S second storage devices; and,
responding to the acknowledgements that were not responded to complete the PUT operation.

17. A computing system, comprising:
at least one processor;
a plurality of storage devices;
at least one machine readable storage medium containing program code that when processed by the at least one processor causes a method to be performed, the method comprising:
receiving a PUT operation request from a user to store a data item;
sending S PUT commands to S of the storage devices to respectively store S replicas or extents for the data item;
confirming to the user that the data item was stored after receiving X acknowledgments from the S storage devices where X<S;
in response to a crash, reading non volatile records for the S storage devices that record successful stores performed by the S storage devices having corresponding acknowledgements that were not responded to;
recognizing from the non volatile records that less than S of the S replicas or extents were successfully stored into the S storage devices; and,
causing those of the S replicas or extents that were not successfully stored to be stored to complete the PUT operation.

18. The method of claim 16 wherein the crash is a crash of a controller that receives the PUT operation.

19. The method of claim 18 where at least one of the S replicas or extents were not successfully stored because a corresponding one of the S storage devices also crashed.

20. The method of claim 1 wherein the non volatile records:
Include respective key values for the successful stores; and/or,
identify the PUT operation for the successful stores.
